(19) United States
(12) Patent Application Publication
(10) Pub. No.: US 2019/0074528 A1
(43) Pub. Date: Mar. 7, 2019

(54) FUEL CELL VEHICLE

(71) Applicant: TOYOTA JIDOSHA KABUSHIKI KAISHA, Toyota-shi (JP)

(72) Inventor: Kazuya MORI, Nisshin-shi (JP)

(73) Assignee: TOYOTA JIDOSHA KABUSHIKI KAISHA, Toyota-shi (JP)

(21) Appl. No.: 16/122,240

(22) Filed: Sep. 5, 2018

(30) Foreign Application Priority Data
Sep. 7, 2017 (JP) 2017-172107

(51) Int. Cl. H01M 8/04082; F17C 11/00; H01M 8/04089; H01M 8/0432; B60L 11/18; B60K 15/07; H01M 8/04746; H01M 8/04701

(52) U.S. Cl. CPC H01M 8/04201; F17C 11/005; H01M 8/04089; H01M 8/04358; H01M 2250/20; B60K 15/07; H01M 8/04746; H01M 8/04701; F17C 2221/012; B60L 11/1883

(57) ABSTRACT

The teaching herein discloses a fuel cell vehicle configured to be supplied with hydrogen gas from a hydrogen supply apparatus. The fuel cell vehicle may include: a hydrogen tank configured to store hydrogen gas; a pressure sensor configured to measure pressure in the hydrogen tank; a temperature sensor configured to measure temperature in the hydrogen tank; and a controller, wherein the controller may be configured to: calculate a supplied amount of the hydrogen gas that has been supplied to the hydrogen tank when supply of the hydrogen gas into the hydrogen tank is completed, based on the pressure and the temperature; and output a message indicating that a currently supplied amount is low when the currently supplied amount is lower than an average of supplied amounts calculated in the past.

### CROSS-REFERENCE TO RELATED APPLICATION

This application claims priority to Japanese Patent Application No. 2017-172107 filed on Sep. 7, 2017, the contents of which are hereby incorporated by reference into the present application.

### TECHNICAL FIELD

The teaching disclosed herein relates to a fuel cell vehicle comprising an hydrogen tank.

### BACKGROUND

A fuel cell vehicle is configured to be capable of receiving supply of hydrogen gas from a hydrogen supply apparatus installed in a hydrogen station. A fuel cell vehicle described in Japanese Patent Application Publication No. 2013-198294 transmits pressure and temperature in a hydrogen tank to a hydrogen supply apparatus by an infrared communicator upon receiving supply of hydrogen gas from the hydrogen supply apparatus. Generally, communication between a fuel cell vehicle and a hydrogen supply apparatus is one-directional communication from the vehicle to the hydrogen supply apparatus.

The hydrogen supply apparatus of Japanese Patent Application Publication No. 2013-198294 is configured to be capable of executing a communication supply mode and a no-communication supply mode as modes for supplying the hydrogen gas to the hydrogen tank of the vehicle. In the communication supply mode, the hydrogen supply apparatus supplies the hydrogen gas to the hydrogen tank at a flow rate corresponding to the pressure and the temperature in the hydrogen tank as obtained from the vehicle through the infrared communicator. The no-communication supply mode is a supply mode for a case where the pressure and the temperature in the hydrogen tank cannot be obtained from the vehicle. In the no-communication supply mode, the hydrogen supply apparatus supplies the hydrogen gas to the hydrogen tank at a preset flow rate. In the communication supply mode, greater amount of the hydrogen gas can be supplied to the hydrogen tank as compared to the no-communication mode because the hydrogen supply apparatus can accurately keep track of a supply state of the hydrogen gas in the hydrogen tank. Thus, travel distance in a case with the supply under the communication supply mode increases as compared to in a case with the supply under the no-communication supply mode.

### SUMMARY

Despite user's expectation of hydrogen gas supply under the communication mode, the no-communication supply mode may be executed due to a communication error (for example caused by contamination, wire disconnection, and the like). In this case, the user may not notice that a supplied amount of the hydrogen gas is lower than usual. Alternatively in a case where the user who uses the communication supply mode on regular basis uses a hydrogen supply apparatus that is not compatible with the communication supply mode, the user also may not notice that the supplied amount of the hydrogen gas is lower than usual.

A fuel cell vehicle disclosed by the teaching herein may be configured to be supplied with hydrogen gas from a hydrogen supply apparatus. This fuel cell vehicle may comprise: a hydrogen tank, a pressure sensor, a temperature sensor, and a controller. The hydrogen tank may be configured to store hydrogen gas. The pressure sensor may be configured to measure pressure in the hydrogen tank. The temperature sensor may be configured to measure temperature in the hydrogen tank. The controller may be configured to calculate a supplied amount of the hydrogen gas that has been supplied to the hydrogen tank when supply of the hydrogen gas into the hydrogen tank is completed, based on the pressure and the temperature. The controller may be configured to output a message indicating that a currently supplied amount is low when the currently supplied amount is lower than an average of supplied amounts calculated in the past.

According to the above fuel cell vehicle, a user can be notified that the supplied amount of the hydrogen gas is lower than usual in an event where a no-communication supply mode was executed due to a communication error although the user expects the hydrogen gas supply under a communication supply mode. Alternatively, also in an event where the user who uses the communication supply mode on regular basis uses a hydrogen supply apparatus that is not compatible with the communication supply mode, the user can be notified that the supplied amount of the hydrogen gas is lower than usual. On the other hand, unnecessary notification to a user who uses the hydrogen gas supply under the no-communication supply mode on regular basis can be avoided.

The aforementioned controller may be configured to output the message when the currently supplied amount is lower than a value obtained by subtracting a predetermined tolerance from the average. The supplied amount varies slightly for each supply, even with supply under the communication supply mode. If the aforementioned message is outputted even in a case where the currently supplied amount is only slightly lower than the average, this may be a false report. A possibility of such a false report can be diminished by configuring the controller to output the aforementioned message when the currently supplied amount is lower than the value obtained by subtracting the predetermined tolerance from the average.

The controller may be configured to exclude the supplied amount for which the message was outputted from calculation of the average. For the user who uses the communication supply mode on regular basis, the average of the supplied amounts in the communication supply mode would be decreased if the supplied amount for which the message was outputted (that is, the supplied amount under the no-communication supply mode) is included in the calculation of the average. By excluding the supplied amount for which the message was outputted from the calculation of the average, accuracy of the average of the supplied amounts in the communication supply mode can be ensured.

The fuel cell vehicle disclosed by the teaching herein may further comprise a transmitter configured to transmit the pressure measured by the pressure sensor and the temperature measured by the temperature sensor to the hydrogen supply apparatus.

### BRIEF DESCRIPTION OF DRAWINGS

FIG. 1 is an explanatory diagram showing a configuration of a fuel cell vehicle;

FIG. 2 is a flow chart showing a supply control process executed by a controller; and

FIG. 3 is a flow chart showing a supply control process of a variant.

### DETAILED DESCRIPTION

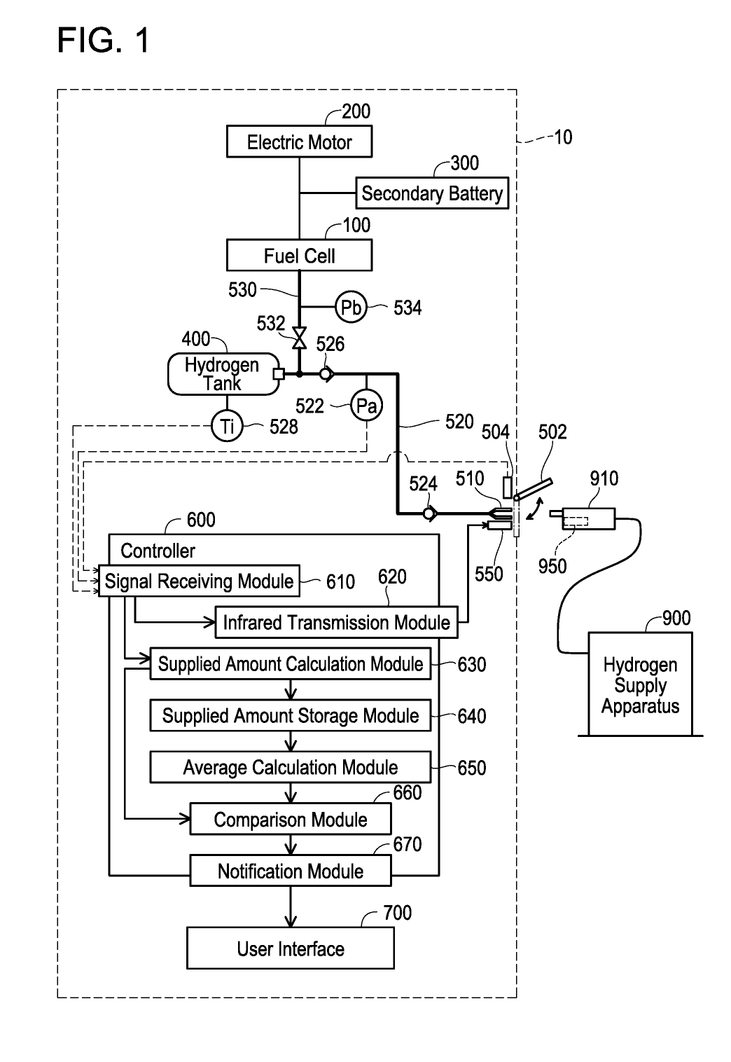

FIG. 1 is an explanatory diagram showing a configuration of a vehicle 10. The vehicle 10 is a fuel cell vehicle. The vehicle 10 includes a fuel cell 100, an electric motor 200 (motor 200), a secondary battery 300, and a hydrogen tank 400. The fuel cell 100 generates electric power using hydrogen gas in the hydrogen tank 400. The motor 200 generates driving power for driving a drive wheel (not shown) of the vehicle 10. The motor 200 may, in some cases, function as a generator for generating regenerative electric power. The secondary battery 300 stores the electric power generated by the fuel cell 100 and the motor 200. The hydrogen tank 400 stores the hydrogen gas.

The vehicle 10 is configured to be capable of receiving hydrogen gas supply from a hydrogen supply apparatus 900 installed in a hydrogen station. The hydrogen supply apparatus 900 is provided with a supply nozzle 910 configured to be capable of connecting to the vehicle 10. The hydrogen supply apparatus 900 is configured to supply the hydrogen gas to the hydrogen tank 400 of the vehicle 10 through the supply nozzle 910. The hydrogen supply apparatus 900 includes an infrared receiver 950. The infrared receiver 950 is provided in the supply nozzle 910. The infrared receiver 950 is configured to receive pressure and temperature in the hydrogen tank 400 from the vehicle 10 by infrared communication.

In a case where the pressure and the temperature in the hydrogen tank 400 can be obtained from the vehicle 10 via the infrared receiver 950, the hydrogen supply apparatus 900 supplies the hydrogen gas to the hydrogen tank 400 at a flow rate corresponding to the pressure and the temperature in the hydrogen tank 400 obtained from the vehicle 10. Hydrogen gas supply performed by determining the flow rate based on the pressure and the temperature transmitted from the vehicle 10 will be termed a communication supply mode. On the other hand, in a case where the pressure and the temperature in the hydrogen tank 400 cannot be obtained from the vehicle 10 via the infrared receiver 950 the hydrogen supply apparatus 900 supplies the hydrogen gas to the hydrogen tank 400 at a preset flow rate. Hydrogen gas supply performed at the preset flow rate will be termed a no-communication supply mode. In the communication supply mode, greater amount of the hydrogen gas can be supplied to the hydrogen tank 400 as compared to the no-communication mode, because the supplied amount of the hydrogen gas in the hydrogen tank 400 of the vehicle 10 can more accurately be kept track by the hydrogen supply apparatus 900. Since the supply under the communication supply mode allows to supply a greater amount of the hydrogen gas than under the no-communication mode, a longer travel distance can be achieved.

The vehicle 10 includes a supply port lid 502, a lid sensor 504, a hydrogen supply port 510, a hydrogen introduction pipe 520, a hydrogen supply pipe 530, an infrared transmitter 550, a controller 600, and a user interface 700. The hydrogen introduction pipe 520 is provided with a pressure sensor 522, a supply port-side check valve 524, and a tank-side check valve 526. The hydrogen tank 400 is provided with a temperature sensor 528. The hydrogen supply pipe 530 is provided with a hydrogen supply valve 532 and a pressure sensor 534.

The supply port lid 502 of the vehicle 10 is a cover for covering the hydrogen supply port 510. The supply port lid 502 can be opened and closed by hand. Insertion of the supply nozzle 910 into the hydrogen supply port 510 becomes enabled by opening the supply port lid 502.

The lid sensor 504 of the vehicle 10 detects opening and closing of the supply port lid 502. The lid sensor 504 is configured to output to the controller 600 a detection signal indicating that the supply port lid 502 is open or a detection signal indicating that the supply port lid 502 is closed.

The hydrogen supply port 510 of the vehicle 10 is configured to be capable of connecting to the hydrogen supply apparatus 900. The hydrogen supply port 510 corresponds to an end portion of the hydrogen introduction pipe 520. The hydrogen supply port 510 has a shape that fits with the supply nozzle 910 of the hydrogen supply apparatus 900. The hydrogen supply port 510 is configured to receive hydrogen gas supply to the hydrogen tank 400 from the supply nozzle 910.

The hydrogen introduction pipe 520 of the vehicle 10 is a pipe that guides the hydrogen gas from the hydrogen supply port 510 to the hydrogen tank 400. The supply port-side check valve 524 is configured to prevent backflow of the hydrogen gas to the hydrogen supply port 510. The tank-side check valve 526 is configured to prevent backflow of the hydrogen gas from the hydrogen tank 400 to the hydrogen introduction pipe 520.

The pressure sensor 522 of the vehicle 10 is configured to measure pressure Pa in the hydrogen introduction pipe 520 between the supply port-side check valve 524 and the tank-side check valve 526. The pressure sensor 522 is configured to output a measurement signal indicating the pressure Pa to the controller 600. Upon when the hydrogen gas is supplied from the hydrogen supply apparatus 900 to the hydrogen tank 400, the pressure Pa measured by the pressure sensor 522 correlates with tank pressure Pi which is pressure in the pressure sensor 522. Thus, upon when the hydrogen gas is supplied from the hydrogen supply apparatus 900 to the hydrogen tank 400, the pressure sensor 522 functions as a device for measuring the tank pressure Pi.

The temperature sensor 528 of the vehicle 10 is configured to measure tank temperature Ti which is temperature in the hydrogen tank 400. The temperature sensor 528 is configured to output a measurement signal indicating the tank temperature Ti to the controller 600.

The hydrogen supply pipe 530 of the vehicle 10 is a pipe that guides the hydrogen gas from the hydrogen tank 400 to the fuel cell 100. The hydrogen supply valve 532 adjusts a supply amount of the hydrogen gas from the hydrogen tank 400 to the fuel cell 100. The pressure sensor 534 is configured to measure pressure Pb in the hydrogen supply pipe 530 between the hydrogen supply valve 532 and the fuel cell 100. The hydrogen gas can be supplied from the hydrogen tank 400 to the fuel cell 100 at desired pressure by controlling the hydrogen supply valve 532 based on a measurement signal from the pressure sensor 534.

The infrared transmitter 550 of the vehicle 10 is configured to transmit information based on an instruction from the controller 600. A signal transmitted by the infrared transmitter 550 is received by the infrared receiver 950 of the hydrogen supply apparatus 900. Upon when the hydrogen gas is supplied from the hydrogen supply apparatus 900 to the hydrogen tank 400, the infrared transmitter 550 transmits the tank pressure Pi and the tank temperature Ti by infrared communication based on an instruction from the controller 600.

Data can be transmitted from the vehicle 10 to the hydrogen supply apparatus 900, but there is no means for transmitting data from the hydrogen supply apparatus 900 to the vehicle 10. That is, the communication between the vehicle 10 and the hydrogen supply apparatus 900 is one-directional communication from the vehicle 10 to the hydrogen supply apparatus 900. This one-directional communication protocol is employed to suppress cost of the hydrogen supply apparatus 900.

The controller 600 of the vehicle 10 is configured to control the supply of the hydrogen gas from the hydrogen supply apparatus 900 to the hydrogen tank 400. The controller 600 is provided with various functional modules such as a signal receiving module 610, an infrared transmission module 620, a supplied amount calculation module 630, a supplied amount storage module 640, an average calculation module 650, a comparison module 660, and a notification module 670. The functional modules of the controller 600 are implemented by software based on a computer program. The controller 600 is constituted of a central processing unit, a memory, and various I/O ports (input/output ports). The program describing the signal receiving module 610 and the like is stored in the memory. At least a part of the functional modules of the controller 600 may be implemented by hardware based on circuit configurations.

The signal receiving module 610 is configured to receive output signals from the lid sensor 504, the pressure sensor 522, and the temperature sensor 528. The infrared transmission module 620 is configured to transmit the tank pressure Pi measured by the pressure sensor 522 and the tank temperature Ti measured by the temperature sensor 528 to the hydrogen supply apparatus 900 by infrared communication via the infrared transmitter 550.

The supplied amount calculation module 630 is configured to calculate a supplied amount U based on the tank pressure Pi and the tank temperature Ti. The supplied amount U is a total amount of the hydrogen gas in the hydrogen tank 400 upon when the hydrogen gas supply by the hydrogen supply apparatus 900 to the hydrogen tank 400 is completed. The supplied amount storage module 640 is configured to store supplied amounts U that were calculated in the past by the supplied amount calculation module 630. The average calculation module 650 is configured to calculate an average Ua of the supplied amounts U that were calculated in the past by the supplied amount calculation module 630.

The comparison module 660 is configured to compare a currently supplied amount U calculated by the supplied amount calculation module 630 with the average Ua of the supplied amounts U calculated by the supplied amount calculation module 630 in the past. The notification module 670 is configured to output a message (data) to the user interface 700 in a case where the currently supplied amount U is lower than a value obtained by subtracting a predetermined tolerance Vr from the average Ua. The message indicates that the currently supplied amount U is lower than the average Ua of the past. The tolerance Vr is set, for example, to 10% of the average Ua.

The user interface 700 of the vehicle 10 is a display configured to provide information to the user of the vehicle 10. The user interface 700 (display) is provided together with a speedometer and the like in an instrument panel (not shown) of the vehicle 10. Based on the message transmitted from the notification module of the controller 600, the user interface 700 is configured to display a notification that “The supplied amount is lower than usual. Confirmation on whether the communication supply mode was executed is recommended.”, for example.

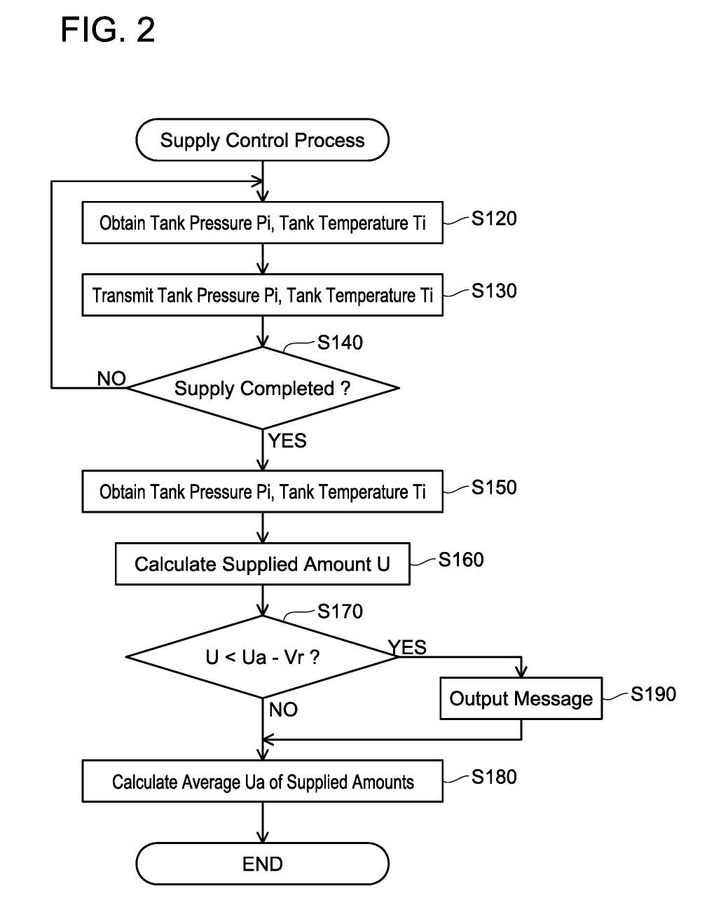

FIG. 2 is a flow chart showing a supply control process executed by the controller 600. When it is detected that the supply port lid 502 is opened, the controller 600 starts the supply control process. The opening of the supply port lid 502 can be detected by the lid sensor 504.

The controller 600 acquires the tank pressure Pi and the tank temperature Ti (step S120). As aforementioned, the tank pressure Pi is measured by the pressure sensor 522 and the tank temperature Ti is measured by the temperature sensor 528.

After the acquisition of the tank pressure Pi and the tank temperature Ti (step S120), the infrared transmission module 620 of the controller 600 transmits data of the tank pressure Pi and the tank temperature Ti to the infrared transmitter 550. The infrared transmitter 550 transmits the tank pressure Pi and the tank temperature Ti to the hydrogen supply apparatus 900 by infrared communication (step S130).

After the transmission of the data of the tank pressure Pi and the tank temperature Ti, the controller 600 determines whether or not the hydrogen gas supply from the hydrogen supply apparatus 900 to the hydrogen tank 400 is completed (step S140). When it is detected that the supply port lid 502 is closed, the controller 600 determines that the hydrogen gas supply is completed. As aforementioned, the opening and closing of the supply port lid 502 are detected by the lid sensor 504. The controller 600 repeatedly executes the processes of acquiring and transmitting the tank pressure Pi and the tank temperature Ti (steps S120, S130) until the hydrogen gas supply is completed (step S140: NO).

When the hydrogen gas supply is completed (step S140: YES), the controller acquires the tank pressure Pi and the tank temperature Ti at the completion of the supply (step S150). The controller 600 receives data from the pressure sensor 522 and the temperature sensor 528 at the completion of the supply, and thereby acquires the tank pressure Pi and the tank temperature Ti.

After the acquisition of the tank pressure Pi and the tank temperature Ti at the completion of the supply, the supplied amount calculation module 630 of the controller 600 calculates the supplied amount U at the completion of the supply (step S160). The supplied amount U is calculated based on the tank pressure Pi and the tank temperature Ti at the completion of the supply. The supplied amount storage module 640 of the controller 600 stores the currently supplied amount U together with the supplied amounts U of the past.

After the calculation of the supplied amount U, the comparison module 660 of the controller 600 compares the currently-calculated supplied amount U with the average Ua of the supplied amounts U calculated in the past (step S170). More specifically, the comparison module 660 determines whether or not the currently supplied amount U is lower than “average Ua−tolerance Vr”. The average Ua is a value which was calculated in the supply control process executed last time. The supplied amount varies each time, even if the supply is executed under the same mode. The tolerance Vr is set within a range of this variation. The tolerance Vr is set, for example, to 10% of the average Ua.

In a case where the currently supplied amount U is higher than “average Ua−tolerance Vr” (step S170: NO), the average calculation module 650 of the controller 600 recalculates the average Ua using the currently supplied amount U (step S180). In other words, the average calculation module 650 updates the average Ua using the currently supplied amount U. The average Ua as currently calculated is used in the supply control process that is to be executed next time. The average calculation module 650 may calculate an average (moving average) of the latest ten supplied amounts U in the past instead of the aforementioned average calculation method. The controller 600 terminates the supply control process of FIG. 2 after the calculation of the average Ua.

On the other hand, in a case where the currently supplied amount U is lower than “average Ua−tolerance Vr” (step S170: YES), the notification module 670 of the controller 600 outputs a message (data) (step S190). The message (data) indicates that the currently supplied amount U is lower than the average Ua. As aforementioned, the notification module 670 of the controller 600 transmits this message (data) to the user interface 700. The user interface 700 (display) displays the message from the controller 600, that is, the message indicating that the currently supplied amount is lower than the average of the supplied amounts in the past. Alternatively, the user interface 700 may display a notification that “The supplied amount is lower than usual. Confirmation on whether the communication supply mode was executed is recommended.”. After the output of the message indicating that the currently supplied amount U is lower than the average Ua, the controller 600 executes the process of calculating the average Ua of the supplied amounts U (step S180), and terminates the supply control process of FIG. 2. The process of step S180 is as mentioned earlier.

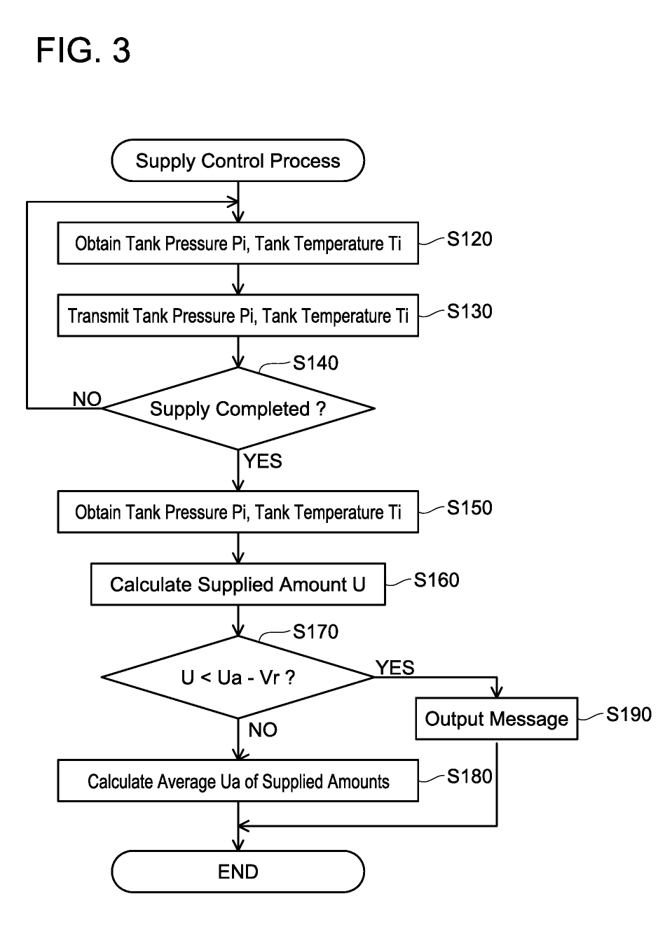

A supply control process of a variant will be described. FIG. 3 is a flowchart of the supply control process of the variant. Its difference from the flowchart of FIG. 2 is that the average calculation (step S180) is skipped after the process of step S190. That is, in this variant, the controller 600 excludes the currently supplied amount U from the average calculation in the case where the message (data) indicating that the currently supplied amount U is lower than the average Ua has been outputted. By such a process, the supplied amount U that has become a target of notification is excluded from the calculation of the average Ua, so an excessive variation in the average Ua can be suppressed. This process is advantageous in being able to ensure accuracy of the average in the communication supply mode for the user who uses the communication supply mode on regular basis.

According to the aforementioned embodiments, when the supplied amount is lower than usual, the user who uses the hydrogen gas supply under the communication supply mode on regular basis can be notified with a message indicating such a situation. For example, the supplied amount becomes lower than usual when the no-communication supply mode is executed due to some errors in infrared communication or when a hydrogen supply apparatus that is not compatible with the communication supply mode is used. When the supplied amount is lower than usual, the traveling distance which the user expects cannot be achieved. The user can be acknowledged that the traveling distance to be achieved by the current supply will become shorter than usual.

On the other hand, the vehicle 10 can avoid unnecessary notification to the user who uses the hydrogen gas supply under the no-communication supply mode on regular basis.

Some points to be notified about the technique disclosed in the embodiments will be described. The supplied amount U means a total amount of the hydrogen gas in the hydrogen tank 400 upon when the hydrogen gas supply by the hydrogen supply apparatus 900 to the hydrogen tank 400 is completed. The vehicle 10 may include two or more hydrogen tanks 400.

In the process of determining the completion of supply (step S140), the controller 600 may determine the completion of the hydrogen gas supply based on changes in the pressure Pa measured by the pressure sensor 522.

In the process of notifying that the currently supplied amount U is lower than the average Ua (step S180), the user interface 700 may output, instead of the notification, a voice message indicating that the currently supplied amount U is lower than the average Ua of the supplied amounts of the past or both of the notification and the voice message.

The tolerance Vr in step S170 of FIGS. 2 and 3 may be zero. That is, the controller 600 may be configured to output the message (data) indicating that the supplied amount is low when the currently supplied amount U is lower than the average Ua. However, the following advantage can be achieved by setting the tolerance Vr. When the tolerance Vr is zero, the aforementioned message will be outputted even in a case where the currently supplied amount U is slightly lower than the average Ua. In this case, this may be a false report. A possibility of such a false report can be diminished by configuring the controller 600 to output the aforementioned message when the currently supplied amount U is lower than a value obtained by subtracting the predetermined tolerance Vr from the average Ua.

While specific examples of the present invention have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

What is claimed is:

1. A fuel cell vehicle configured to be supplied with hydrogen gas from a hydrogen supply apparatus, the fuel cell vehicle comprising:
a hydrogen tank configured to store hydrogen gas;
a pressure sensor configured to measure pressure in the hydrogen tank;
a temperature sensor configured to measure temperature in the hydrogen tank; and
a controller,
wherein
the controller is configured to:
calculate a supplied amount of the hydrogen gas that has been supplied to the hydrogen tank when supply of the hydrogen gas into the hydrogen tank is completed, based on the pressure and the temperature; and
output a message indicating that a currently supplied amount is low when the currently supplied amount is lower than an average of supplied amounts calculated in the past.

2. The fuel cell vehicle of claim 1, wherein the controller is configured to output the message when the currently supplied amount is lower than a value obtained by subtracting a predetermined tolerance from the average.

3. The fuel cell vehicle of claim 1, wherein the controller is configured to exclude a supplied amount for which the message was outputted from calculation of the average.

4. The fuel cell vehicle of claim 1, further comprising a transmitter configured to transmit the pressure measured by the pressure sensor and the temperature measured by the temperature sensor to the hydrogen supply apparatus.
